(19) United States
(12) Patent Application Publication
(10) Pub. No.: US 2019/0184830 A1
(43) Pub. Date: Jun. 20, 2019

(54) METHOD AND APPARATUS FOR DISPLAY INTERACTION MIRRORING

(71) Applicant: FORD GLOBAL TECHNOLOGIES, LLC, Dearborn, MI (US)

(72) Inventor: Jose Daniel Herrera BARRERA, Ciudad de Mexico (MX)

(21) Appl. No.: 16/284,545

(22) Filed: Feb. 25, 2019

Related U.S. Application Data
(62) Division of application No. 15/710,535, filed on Sep. 20, 2017.

(51) Int. Cl. B60K 35/00; B60R 11/02

(52) U.S. Cl. CPC B60K 35/00; G06F 3/0488; B60R 11/0235

(57) ABSTRACT

A system includes a touch-sensitive panel deployed in a vehicle region between a driver and a front passenger. The system also includes a display deployed in a vehicle region such that the display is viewable from at least a peripheral field of driver vision while the driver watches a road and a processor. The processor is configured to mirror driver hand movements on the first touch-sensitive panel as a displayed selector on the second display.

### CROSS-REFERENCE TO RELATED APPLICATIONS

This application is a divisional of U.S. Ser. No. 15/710,535 filed Sep. 20, 2017, the disclosure of which is hereby incorporated in its entirety by reference herein.

### TECHNICAL FIELD

The illustrative embodiments generally relate to methods and apparatuses for display interaction mirroring.

### BACKGROUND

Texting while driving has been studied in great detail and many studies have concluded that looking down at a phone to text while driving can be as distracting to a driver as driving while intoxicated. A driver must look at a phone, visually resolve a small keyboard view, type a word and review a message. Even if this is done in bits and pieces, the whole process largely involves the driver's point of view being down in their lap and away from the road. Further, quickly re-engaging the steering wheel with the typing hand may involve dropping a phone, which some drivers may be unwilling to day. Finally, many drivers do a poor job of evaluating road conditions before attempting to text, ignoring present traffic and other dangerous conditions in the interest of responding to a message that has just been received.

In light of the preceding, many municipalities have passed laws prohibiting the use of phones to text, and in some cases even call, while driving. Typically, hands-free devices are still permitted, allowing a driver to answer a call (or speak a text) without having to take a hand off of the wheel or interact with a small device that can be very distracting. Often such controls limit the ability to provide input to certain applications, however, and in a noisy car environment the text-to-voice option may not be particularly effective.

### SUMMARY

In a first illustrative embodiment, a system includes a touch-sensitive panel deployed in a vehicle region between a driver and a front passenger. The system also includes a display deployed in a vehicle region such that the display is viewable from at least a peripheral field of driver vision while the driver watches a road and a processor. The processor is configured to mirror driver hand movements on the first touch-sensitive panel as a displayed selector on the second display

In a second illustrative embodiment, a system includes a processor configured to replicate driver touch input to a touch-sensitive panel by displaying a proxy for a driver's hand on a display, different from the panel. The processor is further configured to determine an environmental condition predefined as a disabling condition under a current set of driving circumstances. The processor is also configured to disable input, responsive to the determined environmental condition and persisting until the determined environmental condition ceases.

In a third illustrative embodiment, a computer-implemented method includes detecting a driver hand contact with a touch sensitive screen. The method also includes displaying a selector on a second screen, the position of the selector corresponding to the detected contact on the first screen. The method further includes reflecting driver hand movements changing position on the touch sensitive screen as movements of the selector on the second screen.

### BRIEF DESCRIPTION OF THE DRAWINGS

FIG. 1 shows an illustrative vehicle computing system;

FIG. 2 shows an illustrative process for control replication;

FIG. 3 shows an illustrative vehicle interior including a control pad and replication screen;

FIG. 4 shows an illustrative safety control process; and

FIG. 5 shows an illustrative safety value adjustment process.

### DETAILED DESCRIPTION

As required, detailed embodiments are disclosed herein; however, it is to be understood that the disclosed embodiments are merely illustrative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

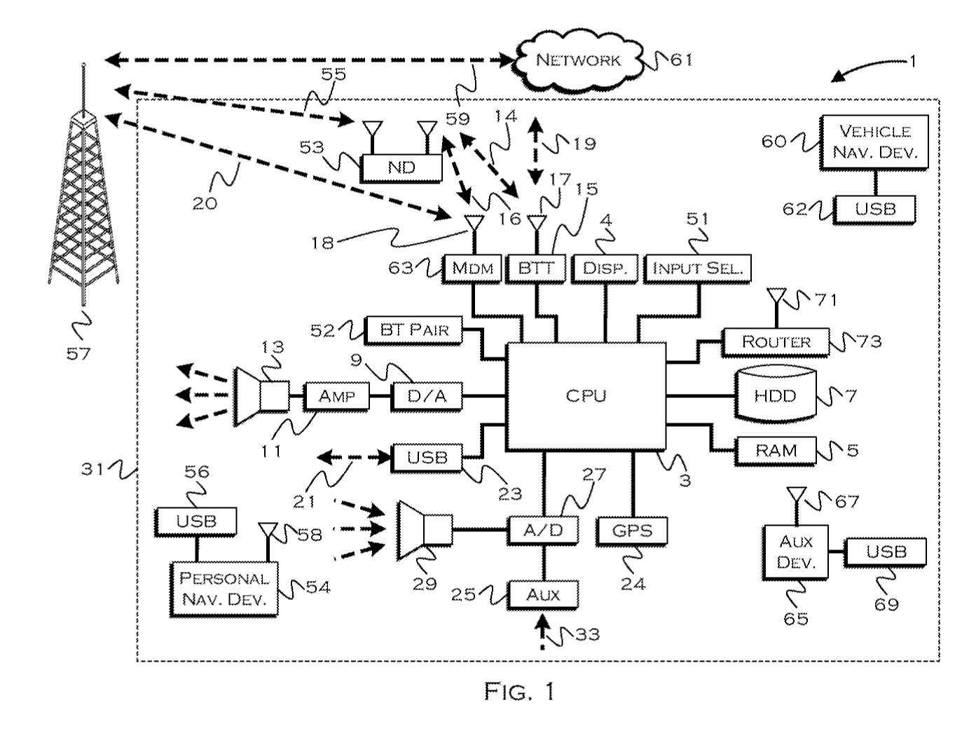

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a Wi-Fi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., Wi-Fi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

The illustrative embodiments consider the fact that many drivers attempt to circumvent, or ignore, laws that prohibit texting while driving. Even in instances where such practices are legally permissible, the drivers often ignore significant safety hazards in the interest of typing a text message. The illustrative embodiments provide a typing-style interaction system that allows a driver to keep a viewpoint focused towards the road, while also electronically considering environmental issues that may make it unreasonable for a driver to remove their eyes from the road, even to look slightly down at a screen.

The provided examples could be easily disengaged completely if prohibited by law, and in areas where use of such examples, and the like, the examples facilitate typing-style interaction with computing systems and applications (e.g., text, apps, etc.) when environmental conditions are appropriate and while allowing the driver to generally keep a forward (road-looking) focus. In this manner, the interaction can be little more distracting than changing a radio station or controlling a climate setting. And, since the illustrative embodiments can limit interaction based on environmental conditions, the interaction can be further contingent on a driver distraction level resulting from external conditions.

In the illustrative example, a touchpad may be provided on which a driver can rest a hand. This pad can be provided at a location that allows a driver to interact with the pad without significant contortion of a body or arm, such as in a center console between a passenger and a driver. Detection of pressure on the touchpad (or other suitable methods for detecting a hand profile, such as visual sensors) can cause the driver's touch-points to be replicated on a display that is provided in a vehicle dashboard. This could also be replicated on a heads-up display and/or in a small profile window in a driver instrument panel, or other location where a driver can view both the display and the road.

By replicating a driver's hand in such a manner, the system can allow a driver to virtually interact with a keyboard displayed on the secondary driver-viewable display. Since the driver can use the touchpad with a hand in a near resting condition, the driver can focus less attention on where the driver is physically touching the display and keep more attention on the road.

While providing the interactive virtual keyboard (virtual in the sense that a driver is not actually touching the keyboard), the system can also detect an environmental change that may make typing less appropriate. In such circumstances, the system can disengage input capability to allow a driver to use both hands on the wheel and fully focus attention on the changed circumstance.

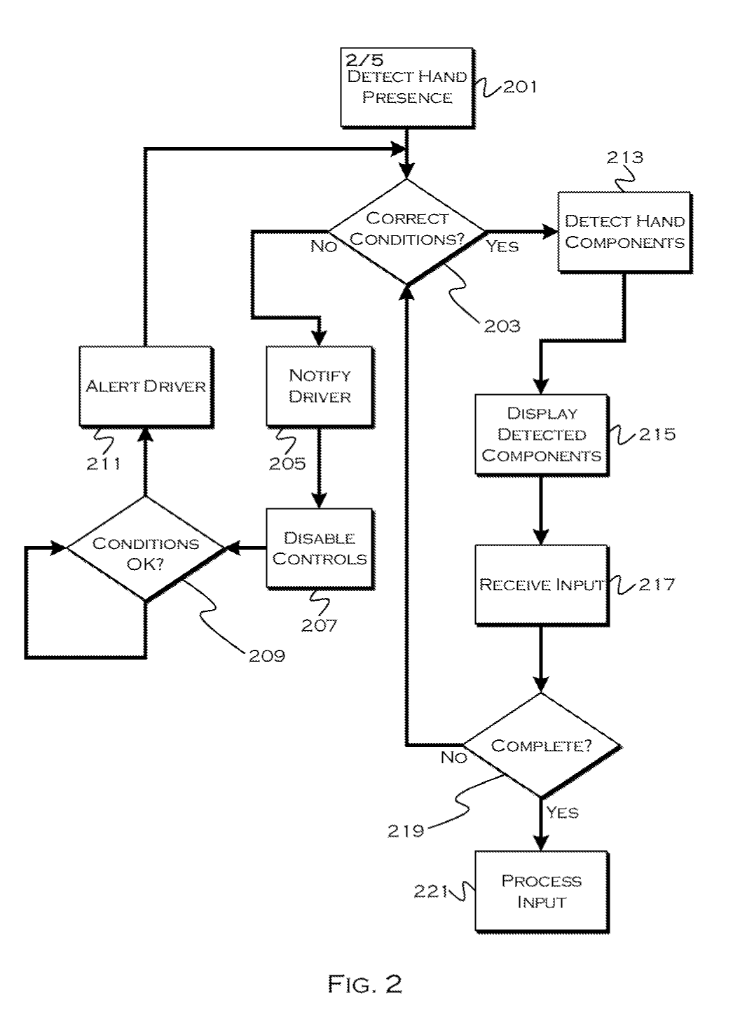

FIG. 2 shows an illustrative process for control replication. In this illustrative example, the touchpad (interaction device) is enabled for use and detects 201 a touch from a driver. In some example, the touchpad may require multiple contact points from the driver in order to function, in other examples a single touch may be sufficient. Requiring multiple contact points may make it easier to replicate the display of a hand, if touch-detection is used for hand-replication, and may also help prevent incidental contact from creating inadvertent input. On the other hand, it is completely reasonable to provide a system requiring only a single touch point, which may make control easier in some circumstances, and may more closely replicate interactions which users are accustomed to having with their devices.

One the touch has been detected, the process checks environmental conditions 203 to see if input is currently permissible. Depending on legal constraints and/or detected conditions, certain circumstances may cause the vehicle to prevent touch-input. If conditions dictate that input is not permissible, the process may notify 205 the driver and disable 207 any currently enabled controls. While the controls are disable, the process may continue to check 209 for a change in conditions and may notify the driver when conditions are such as to permit control and/or input again. The conditions may include, but are not limited to, traffic above a certain threshold, one or more vehicles within a defined proximity detected in any direction relational to the driver's vehicle, inclement weather, poor road conditions, an upcoming traffic signal or any other reasonable constraint.

If conditions are appropriate for input, the process may detect 213 one or more components of a driver's hand. This could include, for example, palm detection (a large contact point), finger detection, thumb detection, etc. Based on a standard configuration of a human hand and the detected contact points, the system may approximate 215 a recreation of the driver's hand on a secondary vehicle display. While a degree of accuracy of recreation may be nice, the system can also function by simply moving a consistently sized display hand or finger (or cursor) in a reasonable approximation of how the driver's hand is moving. That is, since the driver is not actually touching a key to be selected, as long as the system shows that a current touch or tap will select a certain key, an exact correlation to the driver's hand is less relevant, because the desired effect (typing the letter) will be confirmed based on the virtually displayed hand, whether or not the hand and/or hand location has a particular correspondence to the driver's actual hand. That said, the displayed hand or other selector should move in approximate concert with the driver's hand on the interaction device, so that the driver can know how to move the hand to achieve selection of a different letter or selectable object. (That is, if the driver wants a letter that is down and to the left of a current virtually selected location, moving a hand or finger a visually approximate distance down and to the left should more or less accomplish movement of the virtual hand or selector in the same manner).

Once the virtual selector (e.g., hand, finger or cursor) is positioned over a letter or object desired for selection, the driver can touch or tap the interaction device and the process can receive 217 the input as though the driver had touched the actual displayed key or object. If the input is complete 219, the process can handle 221 the input. Otherwise, the process can check again for changes in environmental conditions and can act accordingly. The environmental condition check can be ongoing throughout the entire input process, so that input can be disabled at any time in response to a change in conditions.

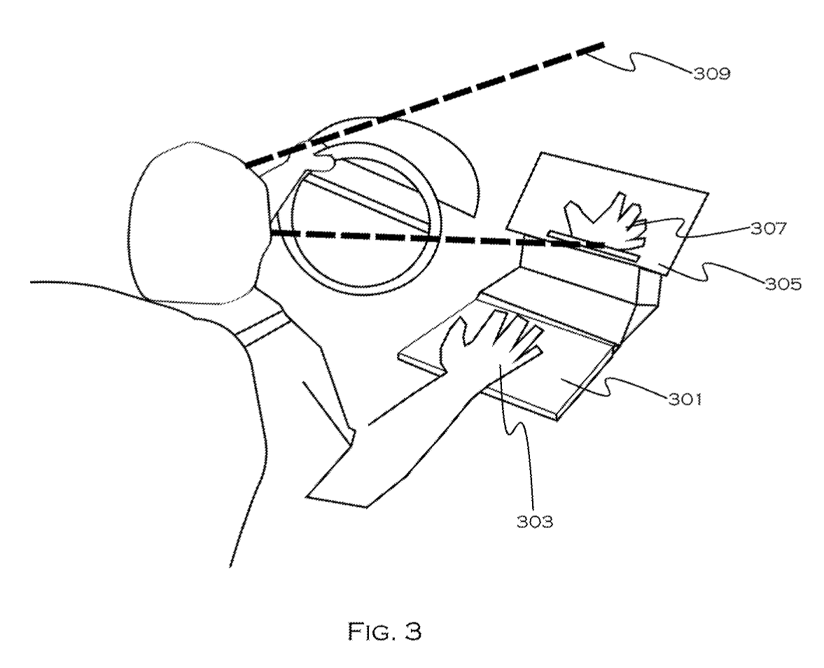

FIG. 3 shows an illustrative vehicle interior including a control pad and replication screen. In this example, the interaction device 301 includes a touch pad disposed in a center console between a driver and a passenger seat. The driver can rest a hand 303 on the touchpad or easily place the hand on the touchpad when input is needed, without significant body position change or contortion.

Once the interaction device is engaged, the vehicle can display a virtual hand 307 on a vehicle display 305 more easily visible while keeping focus on the road. As noted, this can include a center stack display, a driver instrument display, a heads-up display, etc. As can be seen from the figure, the driver can see 309 the road and the display 311 in a forward-looking field of view, without having to look down at a phone or their own hand. The driver can glance at the display 305 when safe, but can largely keep the driver's eyes on the road. If the environmental disengagement is also present, the driver can further generally interact when conditions dictate and not necessarily otherwise.

The display screen and touchpad may be dimensioned the same or differently, but the relative location of objects on the display screen, in one example, corresponds dimensionally to locations on the touch pad. That is, regardless of dimensions, an object 20% towards the center of the display, from the upper left corner, will be selected by placing a finger at the corresponding 20% position on the touchpad. Since any given driver's hand typically rests in a common position, each driver will learn the typical starting point for their hand and can learn the corresponding movements for typing and input accordingly. Other suitable mirroring functions are also possible.

If the above concept were thought as mirroring coordinates, the coordinate values of the first screen could be dimensionally adjusted to be reflected on the second screen. For example, if the first screen was 6×6 inches, and had coordinate pairs every 0.25 inches (for the sake of explanation only), the system would be a 24×24 grid. The display could be an 8×4 display, however, which obviously has different dimensions than the touchpad. This can be accommodated by bounding the display as a square (4×4) or by stretching coordinates to be drawn with reference to the 8 inch axis and compressing coordinates to be drawn with reference to the 4 inch axis. For example, placing a finger on the 1,1 location on the touchpad could cause a representation at the 1.33,0.66 location on the display. Since the keypad or other controllable object can be drawn with reference to the display (as opposed to being mirrored), the image does not suffer from distortion.

In the bounded example, the display could be locked into a 4×4 grid, and all the coordinates from the first display could be scaled down by a factor of 0.66 to be reflected on the bounded second display.

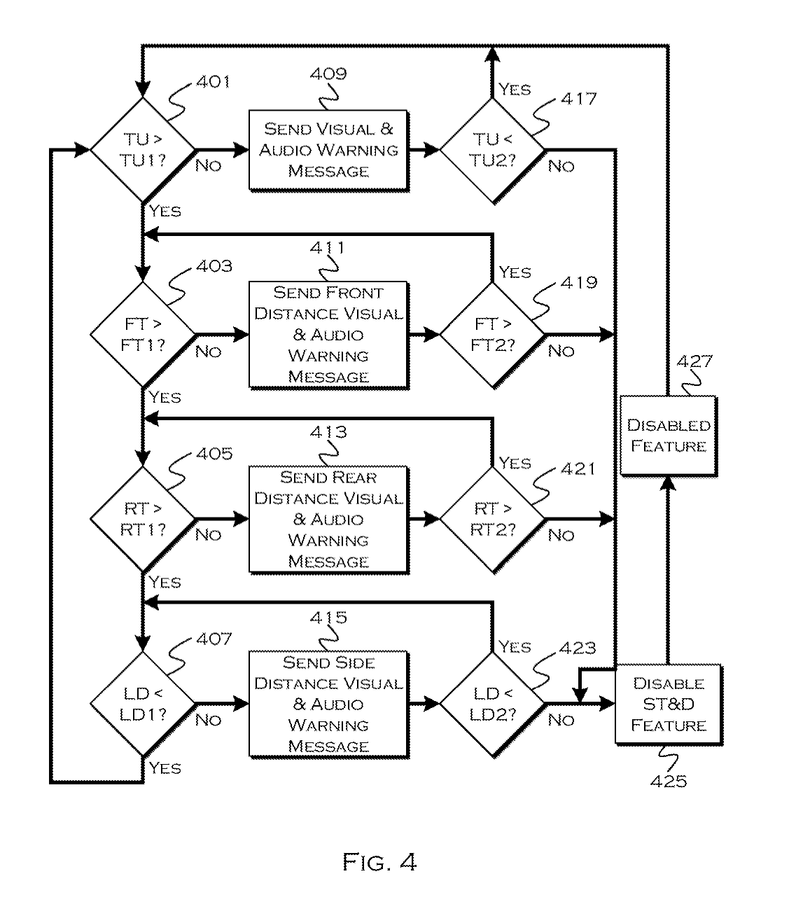

FIG. 4 shows an illustrative safety control process. This process can be ongoing while the vehicle travels, or while the vehicle travels above a certain speed. As can be seen, proximate object detection can occur from multiple directions. Lockout could also be engaged based on weather obtainable from a remote source or detected by a vehicle sensor, an upcoming traffic signal detectable from a navigation system or a vehicle sensor (including a DSRC indicator), or based on other reasonable conditions that might make a driver glancing away from the road inadvisable.

In this example, usage time itself may be a factor that triggers a temporary lockout, in order for a driver not to spend too much time focused on input and too little time focused on driving. The process determines 401 if a current use-time (TU) is less than a current maximum warning time (TU1). If the driver has been typing excessively, the process can warn 409 the driver that the input will be disabled prior to disabling the input. In this example, if the driver wants to prevent input disablement, the driver can cease input for a period of time. If ceasing interaction for more than a threshold cessation time can cause an input counting clock to reset, but if the driver uses 417 the input more than a maximum allowable time (TU2), the process can proceed with disablement.

The process also detects objects that are in front 403, behind 405 or to either side 407 of the vehicle. If a proximity sensor detects an object, the process can send a distance warning telling the driver an approximate distance (in measurement and/or time based on current speed) along with a warning. This can be done for the front 411, rear 413 and side 415 sensors. As with the time, there is a current distance (FT, or RT, or LD), a threshold for a warning (FT1, RT1 or LD1) and a closer threshold for disablement (FT2, RT2 or LD2).

If the current values exceed any of the disablement thresholds, the process can disable 425 the interactive device and/or input capability. The process can alert 427 the user as to what feature is disabled. Re-enablement may be based on the end of a condition associated with disablement or, for example, end of the condition and a minimum passage of time.

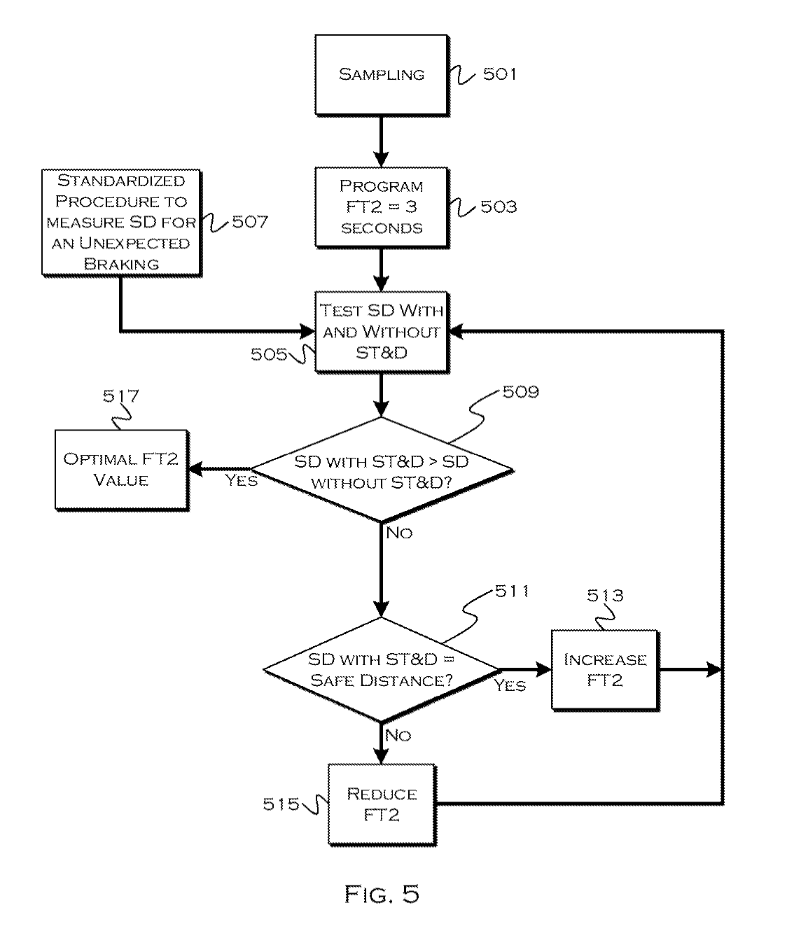

FIG. 5 shows an illustrative safety value adjustment process. In this example, the process receives 501 sampling data representing objects at varied proximities and driver reaction times. Also, in this example, distance is described as temporal proximity, at least with respect to forward and rearward objects. That is, the “distance” is actually the time that it would take to reach a forward object were the object to suddenly stop, and the time it would take for a rearward object to reach the vehicle were the vehicle to currently stop (this example deals with FT, but similar concepts apply to other testing). The testing allows the process to establish a reasonable value for the appropriate FT2 (minimum safe distance at which to disable input) or similar variable.

The process also receives 507 input from a standardization procedure to measure a stopping distance for unexpected braking (e.g., of a forward object) under the present sampled conditions. Using the procedure in conjunction with sampling data, the process can test minimum stopping distances for situations where the input is disabled (e.g., the driver's full attention is on the road) and where the input is enabled (e.g., the driver has divided attention). If the actual stopping distance with or without input would allow the vehicle to stop before impacting an object 509 within a range of the safe distance, the process can consider the value to be an approximated optimized minimum FT2 for the set of sampled conditions. That is, if the vehicle would come to a halt before striking and object but not excessively in arrears of the object, the value is optimized or near-optimized.

If the vehicle would strike the object (SD w/ST&D>SD w/o ST&D) 511 the process can increase the minimum stopping distance FT2. If the vehicle would stop to far in arrears of the object, the process can decrease the minimum stopping distance FT2. While it may not seem reasonable to decrease the minimum stopping distance, having an unlimited value for the minimum stopping distance would cause the system to disable itself the second it ever detected another object, even if the object would have no conceivable impact on a driver's experience.

Using procedures such as the preceding, it is possible to establish a set of FT2 values (and similar values for other vehicular approach angles) that defines varied minimum stopping distances under varied conditions. This helps allow the driver to achieve interface interaction that is more responsive to actual present conditions.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

What is claimed is:

1. A system comprising:
a touch-sensitive panel deployed in a vehicle region between a driver and a front passenger;
a display deployed in a vehicle region such that the display is viewable from at least a peripheral field of driver vision, based on display orientation and location, while the driver watches a road; and
a processor configured to mirror driver hand movements on the first touch-sensitive panel as a displayed selector on the second display.

2. The system of claim 1, wherein the processor is configured to display a hand as the selector on the second display.

3. The system of claim 2, wherein the displayed hand is an approximation of a real hand touching the panel based on contact points of the real hand to the panel used as reference points by the processor to derive the approximation.

4. The system of claim 1, wherein the display is provided as part of a vehicle center-stack.

5. The system of claim 1, wherein the display is provided as part of a vehicle instrument panel.

6. The system of claim 1, wherein the display is provided as part of a heads-up display.

7. The system of claim 1, wherein the processor is configured to display a keyboard on the display and to move the selector over keys on the keyboard as a real hand moves correspondingly on the panel.

8. The system of claim 1, wherein the selector is a representation of a finger.

9. A system comprising:
a processor configured to:
replicate driver touch input to a touch-sensitive panel by displaying a proxy for a driver's hand on a display, different from the panel;
determine an environmental condition predefined as a disabling condition under a current set of driving circumstances; and
disable input to the touch-sensitive panel, responsive to the determined environmental condition and persisting until the determined environmental condition ceases.

10. The system of claim 9, wherein the environmental condition includes a vehicle being within a predefined distance of a driver's vehicle.

11. The system of claim 9, wherein the environmental condition includes a vehicle estimated to be within a predefined stopping time from a driver's vehicle.

12. The system of claim 9, wherein the processor is further configured to disable input responsive to continuous input time exceeding a predefined threshold.

13. The system of claim 9, wherein the processor is configured to wait for a predetermined period of time after the condition ceases, following disabling input, before re-enabling input.

14. A computer-implemented method comprising:
detecting a driver hand contact with a touch sensitive screen;
displaying a selector on a second screen, the position of the selector corresponding to the detected contact on the first screen; and
reflecting driver hand movements changing position on the touch sensitive screen as movements of the selector on the second screen.

15. The method of claim 14, wherein the position of the selector on the second screen is displayed reflecting a corresponding location of the detected contact on the touchpad, so that a coordinate system representing the touchpad is mirrored on the second display via contact representation.

16. The method of claim 15, wherein the coordinate system representing the touchpad is scaled from a touchpad scale to a second-display scale along both axes.

17. The method of claim 15, wherein the coordinate system representing the touchpad is mirrored by bounding the second display to dimensions reflecting touchpad dimensions and then scaling from a touchpad scale to a second-display scale along both axes.

18. The method of claim 15, wherein the selector includes a representation of a driver finger positioned in a relative position to the driver finger on the touchpad determined based on the hand contact.

19. The method of claim 15, wherein the selector includes a representation of a driver hand positioned in a relative position to the driver hand on the touchpad determined based on the hand contact.

20. The method of claim 15, further comprising:
determining an environmental condition predefined as a disabling condition under a current set of driving circumstances; and
disabling input, responsive to the determined environmental condition and persisting until the determined environmental condition ceases.
